(19) United States
(12) Patent Application Publication
(10) Pub. No.: US 2026/0063249 A1
(43) Pub. Date: Mar. 5, 2026

(54) SYSTEM FOR COMPRESSING, STORING AND PROVIDING GAS AND CORRESPONDING METHOD

(71) Applicant: Linde GmbH, Pullach (DE)

(72) Inventors: Daniel FAHRNER, Pullach (DE); Karl Jojo VIDIC, Pullach (DE); Daniel SCHWAB, Pullach (DE)

(21) Appl. No.: 19/106,061

(22) PCT Filed: Aug. 28, 2023
(86) PCT No.: PCT/EP2023/025388

§ 371 Date: Feb. 24, 2025

(30) Foreign Application Priority Data
Sep. 1, 2022 (EP) 22020420.0

(51) Int. Cl. F17C 5/06; C25B 1/02

(52) U.S. Cl. CPC F17C 5/06; C25B 1/02; F17C 2221/012; F17C 2227/0157; F17C 2227/0358

(57) ABSTRACT

A system for compressing, storing and providing gas, in particular hydrogen, having a compressing device, a storage device, an expansion machine and a refrigeration machine, in particular an absorption-type refrigeration machine, wherein the system is configured to compress received gas by means of the compressing device, in particular in multiple stages, and to store the compressed gas in the storage device, wherein the system is configured to refrigerate the compressing device using the refrigeration machine and the expansion machine.

The invention relates to a system for compressing, storing and providing gas, in particular hydrogen, as well as a method for operating such a system, e.g., a hydrogen filling station.

Hydrogen, which is used as fuel for vehicles, for example, can be provided via so-called hydrogen filling stations. Two types of hydrogen filling stations can be distinguished. The first type uses liquid hydrogen as a source and compresses the hydrogen into liquid form. The second type, on the other hand, has a gaseous hydrogen source and compresses the hydrogen into a gaseous state, i.e., the hydrogen is at least initially obtained in a gaseous state and is also compressed into a gaseous state. In addition, two basic system areas can be distinguished at a hydrogen filling station. The first system area concerns the compression of hydrogen, its storage, as well as its conditioning and cooling. The second system area includes a hydrogen dispenser and the associated refueling equipment, such as breakaway and refueling couplings as well as the refueling hose.

In the case of hydrogen filling stations of the second type or comparable systems, considerable amounts of energy are usually required to dissipate or cool away the heat released during compression. Against this background, the object is to make the compression of gas or the operation of a corresponding system as energy-efficient as possible.

### DISCLOSURE OF THE INVENTION

This object is achieved by a system for compressing, storing and providing gas as well as by a method for operating such a system having the features of the independent claims. Preferred embodiments are the subject matter of the dependent claims and the following description.

### Advantages of the Invention

The invention pertains to the compression, storage and provision of gas as well as corresponding systems and their operation. As mentioned at the outset, hydrogen filling stations in particular are considered as such systems. In the following, the invention will therefore be described in particular with reference to hydrogen filling stations, but in essence the principle can also be transferred to other systems for compressing gas, e.g., with other types of gases, or also for other purposes.

As mentioned, two types of hydrogen filling stations can be distinguished. The first type uses liquid hydrogen as a source and compresses the hydrogen into liquid form. The second type, on the other hand, has a gaseous hydrogen source, i.e., it receives the hydrogen in gaseous form and compresses the hydrogen in gaseous form. The present invention pertains to the second type of hydrogen filling stations or, in general, the compression, storage and provision of gas.

Two basic system areas can be distinguished at a hydrogen filling station. The first system area concerns the compression of hydrogen, its storage, as well as its conditioning and cooling. The second system area includes the provision for the specific use, e.g., a hydrogen dispenser and the associated refueling equipment, such as breakaway and refueling couplings as well as the refueling hose. The present invention relates in particular to the first system area, in particular the compression, but also storage and, if necessary, conditioning and cooling of gas.

In a second type of hydrogen filling station, hydrogen is usually compressed in several stages (typically interstage-cooled and cylinder-jacket-cooled) to up to 1000 bar and stored in medium and/or high pressure banks at, for example, between 500 and 1000 bar. When refueling a vehicle at the dispenser of the hydrogen filling station, the gas is usually specifically preconditioned via a so-called pressure ramp regulator regarding pressure and mass flow. In order to refuel hydrogen-powered vehicles with hydrogen in accordance with the current standards (e.g., SAE J2601, JPEC-S0003, Phryde protocol or CEP protocol), it is usually necessary to pre-cool the gas (hydrogen) to temperatures of up to 233.15 K (or −40° C.) before refueling. In the relevant temperature ranges, gaseous hydrogen heats up due to the negative Joule-Thomson effect, in the course of an isenthalpic expansion. Since a pressure gradient (which is again an isenthalpic expansion) occurs during refueling due to overflow between the filling station infrastructure and the vehicle tank, hydrogen filling stations are typically equipped with cooling systems, which usually consist of a compression refrigeration machine and a hydrogen or gas heat exchanger, wherein different cold storage concepts are also used.

The intermediate stages already mentioned (one stage corresponds, for example, to a cylinder with a given pressure stage at a given compression ratio) can be cooled to a temperature close to the ambient temperature, for example, using either a water/air or a water mixture/air heat exchanger. Cooling can also be achieved by using spray-water-assisted cooling with water/air coolers (provided there is sufficient water of sufficient quality available), which can thus be kept at wet-bulb temperature, or, for example, by using so-called chillers. These chillers typically comprise compression refrigeration machines that maintain a cold water circuit that is integrated into the interstage cooling circuit and therefore cools it.

In order to cool away the heat released during refueling of a hydrogen-powered vehicle at the respective expansion point (e.g., at the pressure ramp regulator) as well as the heat released during multi-stage compression of gaseous hydrogen, considerable amounts of energy are required, wherein different target temperatures of the hydrogen may be required depending on the system. This requires additional energy resources and therefore massively increases the specific energy consumption of the system, such as the hydrogen filling station. Globally, a rise in temperature can be observed due to climate change, which places additional demands on the thermal resilience of hydrogen filling stations, as this can lead to increased signs of wear.

Against this background, it is proposed that, in a system for compressing, storing and providing gas, in particular hydrogen, which system has a compression device and a storage device and which is designed to compress the obtained gas by means of the compression device, in particular in several stages, and to store the compressed gas in the storage device, also an expansion machine and a refrigeration machine, in particular an absorption refrigeration machine, be provided. The system is then also designed to cool the compression device, e.g., a multi-stage piston compressor, using the refrigeration machine and the expansion machine. Any type of device or machine that cools or can cool gas through expansion can be considered an expansion machine. The refrigeration machine in the case of the absorption refrigeration machine can, for example, operate with ammonia as the working medium (refrigerant) in the desired temperature range. The use of an expansion machine and a refrigeration machine allows for particularly efficient cooling of the compression device or compressor, especially during different operating phases of the system. Instead of an absorption refrigeration machine, an adsorption refrigeration machine could also be used.

Preferably, the system further comprises a first cold storage device (e.g., a cold storage device) and is configured to guide the stored gas from the storage device via the expansion machine and subsequently the first cold storage device. Since the gas is cooled by the expansion, the first cold storage device or a refrigerant therein can be cooled by means of the expansion machine. These housing components can then be cooled, for example, via a refrigerant flow from the first cold storage device to one or more housing components of the compression device, in particular inlets for the gas and/or a drive. Since the first cold storage device is cooled by means of the expansion machine, the compression device or at least parts thereof can also be cooled by means of the expansion machine.

Preferably, the system further comprises a second cold storage device and is designed to guide the stored gas from the storage device directly (i.e., not via a further machine such as the expansion machine; any valves and the like are not taken into account here, however) via the second cold storage device.

The system can then also be set up to cool the gas by means of the first cold storage device to a different, in particular lower, average temperature than by means of the second cold storage device, and in particular to mix (or combine) gas flows after the first cold storage device and the second cold storage device in order to provide the gas at a desired temperature, e.g., at a provision device such as a dispenser. This second cold storage device is preferably cooled via a refrigerant flow from the refrigeration machine, in particular from a cold outlet of the refrigeration machine.

The system is advantageously also designed to guide the stored gas from the storage device, as required, either via the expansion machine and subsequently the first cold storage device, directly via the second cold storage device, or via the expansion machine and subsequently the first cold storage device and also directly via the second cold storage device, e.g., in a desired distribution ratio, and to make it available for use, in particular via the supply device of the system. This allows the temperature of the gas to be adjusted as required.

Preferably, the system is configured to further cool the one or more housing components of the compression device via a refrigerant flow from the refrigeration machine, in particular by admixing refrigerant into the refrigerant flow of the first cold storage device, further in particular after cooling the second cold storage device. This admixing allows for greater variability and precision in cooling.

Particularly preferably, the compression device has several compressor stages for multi-stage compression of the gas; these can be, for example, several stages in the form of a multi-stage piston compressor. The system is then designed to cool gas between two compressor stages and/or between a last compressor stage and the storage device via a refrigerant flow of the refrigeration machine, which is supplied in the return line of the refrigeration machine, in particular to a warm inlet of the refrigeration machine. For this purpose, for example suitable heat exchangers can be provided after each compressor stage. This allows the temperature level at the inlet of the refrigeration machine to be kept high in order to achieve high efficiency.

When the system is put into operation, the refrigeration machine can be temporarily forcibly heated in order to cool down the first cold storage device. In addition, the second cold storage device can be cooled when the system is put into operation by filling it in an external storage tank or into the storage device or one or more storage banks there. In this way, an operating state can be established.

A particular advantage of the proposed concept is an increase in the efficiency of the overall system or system and an extension of the service life of the system. As a result, significantly less electrical energy is required for cooling, but is partly generated by the expansion machine, which significantly reduces the ecological footprint of the system (no refrigerants with high GWP, “Global Warming Potential”, lower electricity consumption) and considerably reduces the specific energy consumption of the system. This represents a major advantage for the end customer but also for the hydrogen sector as a whole. A further advantage is the extension of the service life of the compression device, e.g., of gas cylinder-piston units (in particular the stage seals made of polymers), since these can be cooled down to optimal temperatures (e.g., to below 50° C. gas inlet temperature in the respective cylinder stage).

At the same time, cold is generated, thus providing optimized cooling of the drive unit of the compression device. By using a refrigeration machine and an expansion machine, thermal load fluctuations of the system can be very well covered by randomly distributed, stochastic refueling profiles, with fluctuating ambient temperatures and variable compressor speeds and compressor running times, which in turn means the advantage of constant target temperatures of the components and media to be cooled.

The invention is schematically represented in the drawing using an exemplary embodiment and is described below with reference to the drawing.

### BRIEF DESCRIPTION OF THE DRAWING

FIG. 1 schematically shows a system according to the invention in a preferred embodiment.

### DETAILED DESCRIPTION OF THE DRAWING

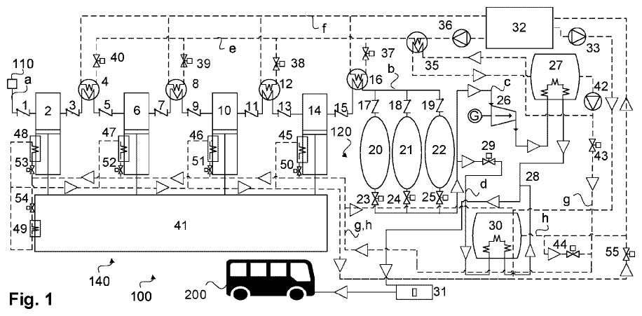

FIG. 1 schematically shows a system 100 according to the invention in a preferred embodiment, by means of which a method according to the invention can also be carried out. In particular, a specific example of a system 100 designed as a hydrogen filling station with a piston compressor as compression device 140 and a storage device 120 comprising, by way of example, three storage banks 20, 21, 22 is shown. A drive 41 of the piston compressor 140 can, for example, be designed mechanically, hydraulically or pneumatically.

In the case shown in FIG. 1 of refueling a vehicle 200 with a running compressor (compression device 140) and a higher hydrogen mass flow than the compressed hydrogen mass flow, the system 100 is supplied with hydrogen, shown here as flow a, from a source 110 such as an electrolysis system, a pipeline, a trailer or a comparable system. It is understood that, as a rule, various components or fittings may be provided or necessary between the source 110 and the piston compressor 140 (e.g., inlet buffer, pressure regulator, sensors, etc.), which, however, are not shown here and are not further relevant to the present invention.

The hydrogen a obtained then enters, for example, via a check valve 1 into the multi-stage piston compressor 140 or a first piston unit 2 therein. The compressor or the piston compressor 140 itself can have, for example, four stages (as shown here), but also more or fewer stages. These stages represent exemplary gas cylinder-piston units 2, 6, 10 and 14, which each have check valves 1, 3, 5, 7, 9, 11, 13, 15 at the gas-side inlet and outlet. The gas cylinder-piston units can also be double-acting.

Between the check valves located between the stages (check valves 3, 5, 7, 9, 11, 13) but also after the last stage (check valve 15; in special cases, e.g., also check valve 1), the hydrogen is cooled by means of heat exchangers 4, 8, 12, 16 to a temperature that is compatible with the sealing systems of the gas cylinder-piston units and/or other components such as those of the storage banks 20, 21, 22 of the storage device 120, e.g., to below 50° C.

After cooling and compression, the hydrogen, here flow b, enters the storage bank 20, 21, 22 to be filled, e.g., via check valves 17, 18, 19. The number of storage banks can vary depending on the system or filling station layout. A cascade refueling of the vehicle 200 is then controlled, for example, by opening and closing the valves 23, 24 and 25 (which are assigned to the storage banks 20, 21, 22).

When the gas leaves the active storage bank, it flows as flow c either through an expansion machine 26, which cools the gas and at the same time regulates the pressure ramp using a generator brake (the electricity generated can be fed into the power grid or used on-site, for example), or the gas flows as flow d, e.g., through a bypass valve 29, which also represents a pressure ramp regulator, and is then, in a second cold storage device 30 or a second cold storage device, directly cooled to an average temperature of, e.g., at least −33° C. The gas which has passed through the expansion machine 26 and is not conducted through the bypass 29, i.e., flow c, reaches a first cold storage device 27 or a first cold storage device which is kept at a low average temperature, e.g.,. of at most −41° C.

A refrigerant (or cold storage medium or refrigerant medium) for the first cold storage device 27 and/or the second cold storage device 30 is, for example, a mixture of water, antifreeze (e.g., ethylene glycol) or brine (e.g., potassium formate and water) and a corrosion-inhibiting medium, and the gas (hydrogen) flowing through the respective cold storage device exchanges the heat of the refrigerant in the respective cold storage device, for example via a heat exchanger positioned therein.

In order to ensure a desired target temperature range of, for example, −33 to −40° C. at a provision device 31 such as a dispenser, the two partial flows c and can be mixed or combined at point 28.

The waste heat, in particular the entire waste heat, of the compression device 140 is converted into usable cold and usable energy via the refrigeration machine, here an absorption refrigeration machine 32, and the expansion machine 26 or by utilization thereof.

The compression device 140 is, as mentioned, designed here as a piston compressor with four stages or compression stages (the gas cylinder-piston units 2, 6, 10, 14). These gas cylinder-piston units are driven, for example, by means of the common drive 41. Between each two compressor stages and between a last compressor stage (gas cylinder-piston unit 14) and the storage device 120, the gas (from flow a) is passed through a heat exchanger 4, 8, 12, 16.

The gas flowing there, i.e., the gas between two compressor stages and between a last compressor stage and the storage device 120, is now cooled via a refrigerant flow e of the absorption refrigeration machine 32, which is fed in the return line f of the absorption refrigeration machine 32, in particular to a warm inlet of the absorption refrigeration machine. For this purpose, the refrigerant is fed to each of the heat exchangers 4, 8, 12, 16 by means of a pump 36; the flow of the refrigerant can be adjusted or regulated, for example, by means of the valves 37, 38, 39, 40. The heat exchangers 4, 8, 12, 16 are connected in parallel here as an example.

In addition, the compression device 140 has various housing components or parts that also generate waste heat that is cooled away. For example, these are the gas cylinder-piston units or, in particular, inlets for the gas or the cylinder jackets. On the inlet side, temperatures of more than 150° C. can occur. Heat exchangers 45, 46, 47 and 48 are provided there as examples. Another component that generates high levels of waste heat is, for example, the drive 41. The heat exchanger 49 is provided there as an example. In order to cool this component, a refrigerant flow g is now guided by means of a pump 42 from the first cold storage device 27 (which, as mentioned, is cooled via the expansion machine 26) to the relevant housing components or from there to the heat exchangers 45, 46, 47, 48, 49; the flow of the refrigerant can be adjusted or regulated, for example, by means of the valves 50, 51, 52, 53, 54. The heat exchangers 45, 46, 47, 48, 49 are connected in parallel here as an example.

It is also expedient if the mentioned housing components of the compression device 140 are cooled via a refrigerant flow h from the absorption refrigeration machine 32. For this purpose, the refrigerant can be first passed from the absorption refrigeration machine 32 by means of a pump 33 via the second cold storage device 30 in order to cool it if necessary, and then mixed or admixed into the refrigerant flow g of the first cold storage device 27. This can be done, for example, via the bypass valve 44. This connection is advantageous, for example, for better regulation of the overall system, especially in partial load operation. Accordingly, there is also a possibility of dividing the return line from the heat exchangers 45, 46, 47, 48, 49, which can be regulated by the valve 55.

Thus, all of the waste heat from the interstage cooling as well as the cylinder jacket cooling (housing components) and the drive cooling is converted by the absorption refrigeration machine 32 and the expansion machine 26 into usable cold and usable mechanical or electrical energy.

It is particularly advantageous to keep the temperature level at the inlet of the absorption refrigeration machine 32 as high as possible in order to achieve maximum efficiency. Therefore, the return line f of the heated refrigerant from the intermediate stages leads directly to the inlet side, which has the high temperature. The cold side of the absorption refrigeration machine 32, on the other hand, cools or keeps the second cold storage device 30 cold.

In principle, even more heat exchangers can be integrated into the scheme shown, wherein a high temperature level is desirable but not absolutely necessary.

When the system 100 is put into operation, the absorption refrigeration machine 32 can be temporarily forcibly heated, e.g., by electric heating cartridges or a comparable system, in order to cool the first cold storage device 27. For this purpose, if the cold storage device 27 is connected to the refrigerant flow e of the absorption refrigeration machine 32, for example via a heat exchanger 35, a further (third) heating coil can be integrated into the heat exchanger 35 with, for example, electrical heating.

The cooling of the second cold storage device 30 can be accomplished during the putting into operation of the system 100 by refueling into or from an external storage tank (preferably type II or III) or into one or more storage banks of the filling station.

All refueling protocols defined by, for example, SAE, JPEC, ISO or CEP (Clean Energy Partnership) or comparable ones can be served with this gas and hydraulic connection diagram or the system 100, since the critical case with −33 to −40° C. as the gas target temperature is already covered by the present principle and warmer refueling temperatures are also used.

1. A system for compressing, storing and providing gas, in particular hydrogen, comprising a compression device, a storage device, an expansion machine and a refrigeration machine, in particular an absorption refrigeration machine,
wherein the system is designed to compress the gas obtained by means of the compression device, in particular in several stages, and to store the compressed gas in the storage device,
wherein the system is configured to cool the compression device using the refrigeration machine and the expansion machine.

2. The system according to claim 1, further comprising a first cold storage device, wherein the system is configured to guide the stored gas from the storage device via the expansion machine and subsequently the first cold storage device.

3. The system according to claim 2, which is configured to cool one or more housing components of the compression device, in particular inlets for the gas and/or a drive, via a refrigerant flow from the first cold storage device to the one or more housing components of the compression device. (Currently amended) The system according to claim 1, further comprising: a second cold storage device, wherein the system is configured to guide the stored gas from the storage device directly via the second cold storage device.

5. The system according to claim 4, which is designed to cool the second cold storage device via a refrigerant flow from the refrigeration machine, in particular from a cold outlet of the refrigeration machine.

6. The system according to claim 4, which is designed to cool the gas by means of the first cold storage device to a different, in particular lower, average temperature than by means of the second cold storage device, and in particular to mix gas flows after the first cold storage device and the second cold storage device in order to provide the gas at a desired temperature.

7. The system according to claim 4, which is designed, depending on requirements, to guide the stored gas from the storage device selectively
via the expansion machine and subsequently the first cold storage device
directly via the second cold storage device, or
via the expansion machine and subsequently the first cold storage device, and also directly via the second cold storage device,
and to make it available for use, in particular via a provision device of the system.

8. The system according to claim 3, which is designed to further cool the one or more housing components of the compression device via a refrigerant flow from the refrigeration machine, in particular by admixing refrigerant into the refrigerant flow of the first cold storage device after cooling the second cold storage device.

9. The system according to claim 1, wherein the compression device has a plurality of compressor stages for multi-stage compression of the gas, and wherein the system is designed to cool gas between two compressor stages and/or between a last compressor stage and the storage device via a refrigerant flow of the refrigeration machine, which is supplied in the return line of the refrigeration machine, in particular to a warm inlet of the refrigeration machine.

10. A method for operating a system for compressing, storing and providing gas, in particular hydrogen, in which the obtained gas is compressed by means of a compression device, in particular in several stages, and in which the compressed gas is stored in a storage device,
wherein the compression device is cooled using a refrigeration machine, in particular an absorption refrigeration machine, and an expansion machine.

11. The method according to claim 10, wherein stored gas from the storage device is passed via the expansion machine and subsequently a first cold storage device, and wherein the refrigeration machine is temporarily forcibly heated when the system is put into operation in order to cool down the first cold storage device.

12. The method according to claim 10, wherein stored gas from the storage device is led directly via a second cold storage device, and wherein the second cold storage device is cooled by refueling in an external storage tank or the storage device when the system is put into operation.

13. A method for operating a system for compressing, storing and providing gas, in particular hydrogen, in which the obtained gas is compressed by means of a compression device, in particular in several stages, and in which the compressed gas is stored in a storage device,
wherein the compression device is cooled using a refrigeration machine, in particular an absorption refrigeration machine, and an expansion machine, for operating a system according to claim 1.
